(19) United States
(12) Patent Application Publication
(10) Pub. No.: US 2023/0383038 A1
(43) Pub. Date: Nov. 30, 2023

(54) CO-MONOMERS FOR POLYMERIZATION OF DECONSTRUCTABLE THERMOSETS

(71) Applicant: The Board of Trustess of the University of Illinois, Urbana, IL (US)

(72) Inventors: Justine Paul, Urbana, IL (US); Oleg Davydovich, Urbana, IL (US); Isabel Qamar, Urbana, IL (US); Jeffrey S. Moore, Urbana, IL (US); Nancy Sottos, Urbana, IL (US); Stephen J. Skala, Urbana, IL (US); Jessica Lawson, Urbana, IL (US); Nil Parikh, Urbana, IL (US)

(21) Appl. No.: 18/325,550

(22) Filed: May 30, 2023

Related U.S. Application Data
(60) Provisional application No. 63/347,345, filed on May 31, 2022.

(51) Int. Cl. C08F 234/02; C08F 4/80; C08K 3/36; C08F 2/44; C08L 45/00

(52) U.S. Cl. CPC C08F 234/02; C08F 4/80; C08K 3/36; C08F 2/44; C08L 45/00; C08L 2203/30; C08L 2314/08

(57) ABSTRACT

Thermoset resin compositions including a compound of formula (I) having a working life and/or a pot life of at least 1 hour are provided. Copolymers prepared from the thermoset resin compositions are further provided. Methods of preparing and polymerizing the thermoset resin compositions are further provided. Delivery devices for preparing thermoset resin compositions are further provided.

### CROSS-REFERENCE TO RELATED APPLICATIONS

The present application claims the benefit of U.S. Provisional Application No. 63/347,345, filed May 31, 2022, the entirety of which is incorporated by reference herein for all purposes.

### STATEMENT REGARDING FEDERALLY FUNDED RESEARCH

This invention was made with government support under DE-AR0001330 subaward 102726 awarded by the Advanced Research Projects Agency—Energy and under HR0011-22-C-0057 awarded by the Defense Advanced Research Projects Agency. The government has certain rights in the invention.

### TECHNICAL FIELD

The present disclosure relates to polymerization reactions.

### BACKGROUND

Frontal polymerization demonstrates great utility as a method of generating high performance thermoset materials and offers a means of three-dimensional printing complex architectures. Conventional methods of three-dimensional printing rely on either incubation of the resin to attain the required viscosity needed to print or via the addition of rheological modifiers, such as fumed silica, was found to increase the viscosity of the resin. However, fumed silica adversely interacted with phosphite inhibitor polymerization co-reagents, which resulted in spontaneous polymerization.

There is a need for chemical species that may participate as inhibitors in polymerization reactions of thermosets without adversely interacting with rheological modifiers.

### SUMMARY

In an example, the present disclosure provides a thermoset resin composition. The thermoset resin composition includes: an amount of a functionalized cycloalkene; a catalyst; and an amount of a compound of formula (I) of up to 20 mol % relative to the amount of the functionalized cycloalkene:

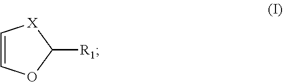

wherein R₁ is selected from the group consisting of hydrogen, substituted or unsubstituted (C₁-C₂₀)alkyl, and substituted or unsubstituted aryl; X is selected from the group consisting of oxygen and CH—R₂; R₂ is selected from the group consisting of hydrogen, substituted or unsubstituted (C₁-C₂₀)alkyl, and substituted or unsubstituted aryl; and each substituted (C₁-C₂₀)alkyl and substituted aryl is independently substituted with one or more (C₁-C₂₀)alkoxy groups or aryloxy groups; and wherein the working life and/or the pot life of the composition is at least 1 hour.

In another example, the present disclosure provides a method of increasing a pot life and/or a working life of a thermoset resin composition. The method includes adding an amount of a compound of formula (I) to the composition, the composition including an amount of a functionalized cycloalkene and a catalyst, the amount of the compound of formula (I) of up to 20 mol % relative to the amount of the functionalized cycloalkene;

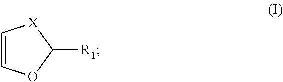

wherein R₁ is selected from the group consisting of hydrogen, substituted or unsubstituted (C₁-C₂₀)alkyl, and substituted or unsubstituted aryl; X is selected from the group consisting of oxygen and CH—R₂; R₂ is selected from the group consisting of hydrogen, substituted or unsubstituted (C₁-C₂₀)alkyl, and substituted or unsubstituted aryl; and each substituted (C₁-C₂₀) and substituted aryl is independently substituted with one or more (C₁-C₂₀)alkoxy groups or aryloxy groups; and wherein the pot life and/or the working life is increased to a duration of at least 1 hour.

In yet another example, the present disclosure provides a method of preparing a copolymer. The method includes agitating a mixture including an amount of a compound of formula (I), an amount of a functionalized cycloalkene, and a catalyst, the amount of the compound of formula (I) of up to 20 mol % relative to the amount of the functionalized cycloalkene to provide a thermoset resin composition;

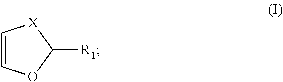

wherein R₁ is selected from the group consisting of hydrogen, substituted or unsubstituted (C₁-C₂₀)alkyl, and substituted or unsubstituted aryl; X is selected from the group consisting of oxygen and CH—R₂; R₂ is selected from the group consisting of hydrogen, substituted or unsubstituted (C₁-C₂₀)alkyl, and substituted or unsubstituted aryl; and each substituted (C₁-C₂₀)alkyl and substituted aryl is independently substituted with one or more (C₁-C₂₀)alkoxy or aryloxy groups. The method further includes heating the thermoset resin composition to produce the copolymer after a duration of a pot life and/or a working life.

In yet another example, the present disclosure provides a delivery device for a thermoset composition. The delivery device includes a reservoir including a mixture including an amount of a functionalized cycloalkene and a compound of formula (I);

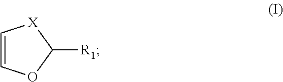

wherein R₁ is selected from the group consisting of hydrogen, substituted or unsubstituted (C₁-C₂₀)alkyl, and substituted or unsubstituted aryl; X is selected from the group consisting of oxygen and CH—R₂; R₂ is selected from the group consisting of hydrogen, substituted or unsubstituted (C₁-C₂₀)alkyl, and substituted or unsubstituted aryl; and each substituted (C₁-C₂₀)alkyl and substituted aryl is independently substituted with one more (C₁-C₂₀)alkoxy groups or aryloxy groups. The delivery device further includes a first pump, optionally a peristaltic pump, in fluid communication with the reservoir and a mixer, optionally an in-line mixer, and configured to deliver the mixture at a flow rate to the mixer. The delivery device further includes a second pump, optionally a syringe pump, in fluid communication with the mixer and configured to deliver a solution of a catalyst at a second flow rate to the mixer. The mixer is configured to agitate the mixture and the catalyst so as to provide the thermoset resin composition. The mixer includes an outlet configured to deliver the thermoset resin composition.

### BRIEF DESCRIPTION OF THE DRAWINGS

In order that the present disclosure may be well understood, there will now be described various forms thereof, given by way of example, reference being made to the accompanying drawings. The components in the figures are not necessarily to scale.

FIG. 1 illustrates optical images of frontal ring-opening metathesis polymerization (“FROMP”) reactions of a thermoset resin composition including 2.5 mol % 2,3-dihydrofuran (“DHF”), prepared according to the principles of the present disclosure;

FIG. 2 illustrates a plot of frontal velocity and maximum temperature of FROMP reactions as a function of the concentration of DHF in the thermoset resin prepared according to the principles of the present disclosure;

FIG. 3 illustrates a plot of glass transition temperature (° C.) of copolymers measured as a function of the concentration of DHF (mol %) in the thermoset resin compositions used to prepare the copolymers according to the principles of the present disclosure, analyzed via differential scanning calorimetry and via dynamic mechanical analysis;

FIG. 4 illustrates representative uniaxial testing of copolymers prepared from thermoset resin compositions including 5-15 mol % DHF, prepared according to the principles of the present disclosure;

FIG. 5 illustrates gel point measurements of thermoset resin compositions as a function of concentration of DHF (mol %) in the thermoset resin compositions, prepared according to the principles of the present disclosure;

FIG. 6 illustrates an optical image of application of a thermoset resin composition, prepared according to the principles of the present disclosure, applied to a substrate heating to 100° C.;

FIG. 7 illustrates an optical image of three-dimensional printed copolymer helices prepared from thermoset resin compositions including 10 mol % DHF, prepared according to the principles of the present disclosure;

FIG. 8 illustrates quantification of byproduct yield via gravimetric analysis after deconstructing copolymers of thermoset resin compositions prepared according to the principles of the present disclosure;

FIG. 9 illustrates cure kinetics of thermoset resin compositions including 1 mol % DHF and 6 wt. % fumed silica, prepared according to the principles of the present disclosure, as measured by differential scanning calorimetry (7° C./min) as function of time, the compositions maintained at constant temperature of 20° C.;

FIG. 10 illustrates viscosity of thermoset resin compositions including DCPD and DHF (1 mol %) as a function of fumed silica concentration (weight %), prepared according to the principles of the present disclosure; and

FIG. 11 illustrates a delivery device for preparation and delivery of thermoset resin compositions prepared according to the principles of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses.

The uses of the terms “a” and “an” and “the” and similar referents in the context of describing the present disclosure (especially in the context of the following claims) are to be construed to cover both the singular and the plural, unless otherwise indicated herein or clearly contradicted by context. The use of the term “plurality of” is defined by the Applicant in the broadest sense, superseding any other implied definitions or limitations hereinbefore or hereinafter unless expressly asserted by Applicant to the contrary, to mean a quantity of more than one. All methods described herein may be performed in any suitable order unless otherwise indicated herein by context.

As will be understood by one skilled in the art, for any and all purposes, all ranges recited herein also encompass any and all possible sub-ranges and combinations of sub-ranges thereof, as well as the individual values making up the range, particularly integer values. It is therefore understood that each unit between two particular units are also disclosed. For example, if 10 to 15 is disclosed, then 11, 12, 13, and 14 are also disclosed, individually, and as part of a range. A recited range (for example, weight percentages or carbon groups) includes each specific value, integer, decimal, or identity within the range. Any listed range can be easily recognized us sufficiently describing and enabling the same range being broken down into at least equal halves, thirds, quarters, fifths, or tenths. As will also be understood by one skilled in the art, all language such as “up to,” “at least,” “greater than,” “less than,” “more than,” “or more,” and the like, include the number recited and such terms refer to ranges that can be subsequently broken down into sub-ranges. In the same manner, all ratios recited herein also include all sub-ratios falling with the broader ratio. Accordingly, specific values recited for radicals, substituents, and ranges are for illustration only; they do not exclude other defined values or other values within defined ranges for radicals and substituents. It will be further understood that the endpoints of each of the ranges are significant both in relation to the other endpoint, and independently of the other endpoint.

One skilled in the art will also readily recognize that where members are grouped together in a common manner, such as in a Markush group, the invention encompasses not only the entire group listed as a whole, but each member of the group individually and all possible subgroups of the main group. Additionally, for all purposes, the invention encompasses not only the main group, but also the main group absent one or more of the group members. The invention therefore envisages the explicit exclusion of any one or more of the members of a recited group.

Accordingly, provisos may apply to any of the disclosed categories or examples whereby any one or more of the recited elements, species, or examples may be excluded from such categories or examples, for example, for use in an explicit negative limitation.

As used herein, the terms “comprise(s),” “include(s),” “having,” “has,” “can,” “contain(s),” and variants thereof, are intended to be open-ended transitional phrases, terms, or words that do not preclude the possibility of additional acts or structures. The present description also contemplates other examples “comprising,” “consisting of,” and “consisting essentially of,” the examples or elements presented herein, whether explicitly set forth or not.

In describing elements of the present disclosure, the terms “1^{st},” “2^{nd},” “first,” “second,” “A,” “B,” “(a),” “(b),” and the like may be used herein. These terms are only used to distinguish one element from another element, but do not limit the corresponding elements irrespective of the nature or order of the corresponding elements.

Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art.

As used herein, the term “about,” when used in the context of a numerical value or range set forth refers to a variation of ±15%, or less, of the numerical value. For example, a value differing by ±15%, ±14%, ±10%, or ±5%, among others, would satisfy the definition of “about,” unless more narrowly defined in particular instances.

The term “alkyl,” by itself or as part of another substituent, refers, unless otherwise stated, to a straight, branched, or cyclic chain aliphatic hydrocarbon (“cycloalkyl”) monovalent radical having the number of carbon atoms designated (in other words, “C₁-C₂₀” means one to twenty carbons, and includes C₂, C₃, C₄, C₅, C₆, C₇, C₈, C₉, C₁₀, C₁₁, C₁₂, C₁₃, C₁₄, C₁₅, C₁₆, C₁₇, C₁₈, and C₁₉). Examples include methyl, ethyl, propyl, isopropyl, cyclopropyl, butyl, isobutyl, sec-butyl, tert-butyl, cyclobutyl, methylcyclopropyl, cyclopropylmethyl, pentyl, neopentyl, hexyl, and cyclohexyl.

The term “alkylene,” by itself or as part of another substituent, refers, unless otherwise stated, to a bivalent aliphatic chain radical that is straight, branched, cyclic, or straight or branched and includes a cycloalkyl group, having the number of carbon atoms (in other words, “C₁-C₂₀” means one to twenty carbons) such as methyl (“C₁alkylene,” or “—CH₂—”) or that may be derived from an alkene by opening of a double bond or from an alkane by removal of two hydrogen atoms from different carbon atoms. Examples include methylene, methylmethylene, ethylene, propylene, ethylmethylene, dimethylmethylene, methylethylene, butylene, cyclopropylmethylene, dimethylethylene, and propylmethylene.

Each of the terms “alkene” and “olefin,” by itself or as part of another substituent, refers, unless otherwise stated, to a stable mono-unsaturated or di-unsaturated or polyunsaturated straight chain, branched chain, or cyclic hydrocarbon (“cycloalkene”), “unsaturated” meaning a carbon-carbon double bond (—CH═CH—). “Monosubstituted” alkenes include only one bond between an alkene double-bonded carbon and an adjacent carbon, such as, for example. CH₂═CH—C. “Disubstituted” alkenes include two bonds between an alkene double-bonded carbon and adjacent carbons, and the adjacent carbons may be bonded to one (CH₂═CC₂) or both (C—CH═CH—C) of the alkene double-bonded carbons. “Trisubstituted” alkenes include three bonds between alkene double-bonded carbons and adjacent carbons (CH═CC₂). “Tetrasubstituted” alkenes include four bonds between alkene double-bonded carbons and adjacent carbons (C₂C═CC₂).

The term “alkenyl,” by itself or as part of another substituent, means, unless otherwise stated, a stable mono-unsaturated or di-unsaturated or poly-unsaturated straight chain, branched chain, or cyclic hydrocarbon group having the stated number of carbon atoms (in other words, “C₂-C₂₀” means two to twenty carbons), “unsaturated” meaning a carbon-carbon double bond (—CH═CH—). Examples include vinyl, propenyl, allyl, crotyl, isopentenyl, butadienyl, 1,3-pentadienyl, 1,4-pentadienyl, cyclopentenyl, cyclopentadienyl, and the higher homologs and isomers. Functional groups representing an alkene are exemplified by —CH═CH—CH₂— and CH₂═CH—CH₂—.

The term “functionalized,” in the context of cycloalkenes, refers, unless otherwise stated, to a cycloalkene being ring-strained or having a nonhydrocarbon substituent on one or more of the carbons of the cyclic moiety of the cycloalkene.

The term “ring-strained,” in the context of cycloalkenes, refers, unless otherwise stated, to the relative higher energy of a cycloalkene as a result of the number of carbons making up one or more of the cyclic moieties of the cycloalkene causing compression or “strain” to the natural angles between carbon-carbon bonds at each carbon atom of the one or more cyclic moieties, wherein the compression or strain would be alleviated (and the energy would be decreased) were the one or more cyclic moieties to undergo a reaction that would “open” the ring at the alkene bond.

The term “alkoxy,” by itself or as part of another substituent, means, unless otherwise stated, an alkyl group having the designated number of carbon atoms, as defined above, connected to the rest of a molecule via an oxygen atom, such as, for example, methoxy, ethoxy, 1-propoxy, 2-propoxy (“isopropoxy”), and the higher homologs and isomers.

The term “aromatic” generally refers to a carbocycle or heterocycle having one or more polyunsaturated rings having aromatic character (in other words, having (4n+2) delocalized π (pi) electrons where n is an integer).

The term “aryl,” by itself or in combination with another substituent, means, unless otherwise stated, a carbocyclic aromatic system containing one or more rings (typically one, two, or three rings) wherein such rings may be attached together in a pendant manner, such as biphenyl, or may be fused, such as naphthalene. Examples may include phenyl, benzyl, anthracyl, and naphthyl. Preferred are phenyl, benzyl, and naphthyl; most preferred are phenyl and benzyl.

The term “aryloxy,” by itself or in combination with another substituent, means, unless otherwise stated, an aryl group connected to the rest of the molecule via an oxygen atom.

The term “frontal polymerization,” refers, unless otherwise stated, to a process in which the polymerization reaction propagates through a vessel or a substance. There are three types of frontal polymerizations: thermal frontal polymerization (“TFP”) that uses an external energy source to initiate the front; photofrontal polymerization (“PFP”), in which the localized reaction is driven by an external UV source; and isothermal frontal polymerization (“IFP”), which relies on the Norrish-Trommsdorff, or gel effect, that occurs when monomer and initiator diffuse into a polymer seed (small piece of polymer). Thermal frontal polymerization begins when a heat source contacts a solution of monomer and a thermal initiator or catalyst. Alternatively, a UV source may be applied if a photoinitiator is also present. The area of contact (or UV exposure) has a faster polymerization rate, and the energy from the exothermic polymerization diffuses into the adjacent region, raising the temperature and increasing the reaction rate in that location. The result is a localized reaction zone that propagates down the reaction vessel as a thermal wave.

The term “ring-opening metathesis polymerization” (“ROMP”), refers, unless otherwise stated, to a type of olefin metathesis chain-growth polymerization that may produce industrially important products. The driving force of the reaction is relief of ring strain in cyclic olefins, which may be referred to as “functionalized cycloalkenes.” Thus, “frontal ring-opening metathesis polymerization” (“FROMP”) entails the conversion of a monomer into a polymer via a localized exothermic reaction zone that propagates through the coupling of thermal diffusion and Arrhenius reaction kinetics. The pot life, gel time, and reaction kinetics may be controlled through various modifications of the polymerization chemistry.

The term “pot life” refers to the amount of time between the mixing of monomer and initiator or catalyst and the point at which frontal polymerization is no longer possible. “Pot life” may also refer to the amount of time it takes for an initial viscosity of a composition to double, or quadruple. Timing starts from the composition is mixed, and is measured at room temperature.

The term “working life” refers to the amount of time a mixture remains low enough in viscosity that the mixture may still be easily applied to a part or substrate in a particular application. For that reason, working life may vary from application to application, and even by the application method of the reactive mixture. Pot life may act as a guide in determining working life by providing a rough timeline of viscosity growth.

Herein is described a new comonomer, a compound of formula (I), for polymerization reactions with functionalized cycloalkenes. In an example of a compound of formula (I), 2,3-dihydrofuran (DHF) is a new comonomer for frontal ring opening metathesis polymerization (FROMP) reaction with dicyclopentadiene (“DCPD”). The incorporation of DHF (≥5 mol %) into the backbone of poly(DCPD) may result in a thermoset resin composition for polymerization into a deconstructable copolymer. Significantly, even at low loadings (<5%), DHF may reduce the reactivity profile of Grubbs second generation catalyst (G2), which may limit the likelihood of spontaneous polymerization of thermoset resin composition and thereby increase the pot life of the reaction mixture. Gelation kinetics of the examples of thermoset resin compositions of the present disclosure may be tuned as a function of DHF concentration and the reaction mixture may be advantageously gelled to achieve a specific viscosity desirable and/or advantageous for three-dimensional printing.

Enablement of three-dimensional printing of deconstructable, high-quality thermosets that may advantageously possess an extended pot life and/or working life is described herein. Minimal infrastructure is required to support this process, as it can be adapted to standard extrusion printing devices. A mixed gelled solution including functionalized cycloalkene(s), compound(s) of formula (I), and a catalyst are extruded through a die to form an “extrudate,” for example, from a print head onto a heated surface. As the printing continues, a propagating polymerization front forms and propagates through the extrudate.

In an example, the present disclosure provides a thermoset resin composition. In certain examples, the thermoset resin composition includes an amount of a functionalized cycloalkene, a catalyst, and an amount of a compound of formula (I).

Examples of functionalized cycloalkenes may include:

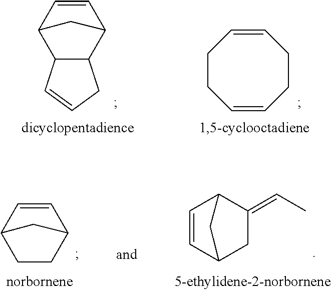

Examples of catalysts may include a Grubbs catalyst. In certain examples, the catalyst may be Grubbs second generation catalyst (“G2”), the structure of which is:

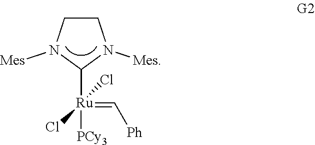

In an example, the present disclosure provides a compound of formula (I):

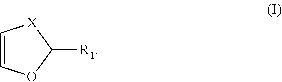

In certain examples, R₁ may be selected from hydrogen, substituted or unsubstituted (C₁-C₂₀)alkyl, and substituted or unsubstituted aryl. In other examples, X may be selected from oxygen and CH—R₂. In still other examples, R₂ may be selected from hydrogen, substituted or unsubstituted (C₁-C₂₀)alkyl, and substituted or unsubstituted aryl. In still other examples, each substituted (C₁-C₂₀)alkyl and substituted aryl may be independently substituted with one or more (C₁-C₂₀)alkoxy groups or aryloxy groups.

Examples of compounds of formula (I) may include:

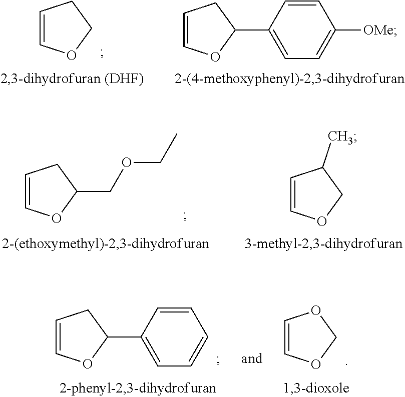

Compounds of formula (I) may be low-cost, commercially available monomeric co-reagents for polymerization reactions with a functionalized cycloalkene. Examples of polymerization reactions may include ring-opening metathesis polymerization and frontal ring-opening metathesis polymerization (“FROMP”). Incorporation of compounds of formula (I) into a polycycloalkenyl backbone at mole percents of greater than or equal to 5 mol % may result in a deconstructable thermoset material.

In an example, the mole percent of the compound of formula (I) relative to the amount of functionalized cycloalkene may be from about 0.5 mol % to about 20.0 mol %, or from about 1.0 mol % to about 19.0 mol %, or to about 18.0 mol %, or to about 17.0 mol %, or to about 16.0 mol or to about 15.0 mol %, or to about 14.0 mol %, or to about 13.0 mol %, or to about 12.0 mol or to about 11.0 mol %, or to about 10.0 mol %, or to about 9.0 mol %, or to about 8.0 mol %, or to about 7.0 mol %, or to about 6.0 mol %, or to about 5.0 mol %, or to about 4.0 mol %, or to about 3.0 mol %, or to about 2.0 mol %, or to about 1.0 mol %; or from about 2.0 mol %, or from about 3.0 mol %, or from about 4.0 mol %, or from about 5.0 mol %, or from about 6.0 mol %, or from about 7.0 mol %, or from about 8.0 mol %, or from about 9.0 mol %, or from about 10.0 mol %, or from about 11.0 mol %, or from about 12.0 mol %, or from about 13.0 mol %, or from about 14.0 mol %, or from about 15.0 mol %, or from about 16.0 mol %, or from about 17.0 mol %, or from about 18.0 mol %, or from about 19.0 mol % to about 20 mol %; or a range formed from any two of the foregoing mole percents; including any sub-ranges therebetween. In certain examples, the working life and/or the pot life of the composition may be tunable based upon the amount of the compound of formula (I) in the composition.

Significantly, even at low loadings (less than 5 mol %), compounds of formula (I) may reduce the reactivity profile of Grubbs second generation catalyst (G2), which may limit the likelihood of spontaneous polymerization of a thermoset resin, and may thereby increase the pot life of a resin reaction mixture. Gelation kinetics of the resin reaction mixture may be tuned as a function of the concentration of a compound of formula (I). Consequently, a resin reaction mixture may be conveniently gelled to achieve a viscosity desirable for three-dimensional printing by polymerization.

In an example, the pot life and/or the working life of a thermoset resin of the present disclosure including a compound of formula (I) may be at least 15 minutes, or at least 30 minutes, or at least 45 minutes, or at least 1 hour, or at least 1.5 hours, or at least 2 hours, or at least 2.5 hours, or at least 3 hours, or at least 3.5 hours, or at least 4 hours, or at least 4.5 hours, or at least 5 hours, or at least 5.5 hours, or at least 6 hours; or a range formed from any two of the foregoing durations of time; including any sub-ranges therebetween.

Resin reaction mixtures including a compound of formula (I) may offer advantages over three-dimensional printing resins that do not include a compound of formula (I). In contrast to phosphite inhibitors, the use of a compound of formula (I) in combination with a rheological modifier may not demonstrate the significant adverse interactions that may be observed between rheological modifier and phosphite inhibitors. Examples of rheological modifier may include fumed silica. Accordingly, compounds of formula (I) may advantageously provide three-dimensional printing resins with rheological modification and significantly increased resin pot life.

In an example, the weight percent of the rheological modifier may be from about 0.5 weight percent to about 10.0 weight percent, relative to 100 weight percent of a composition, or from about 1.0 weight percent to about 10.0 weight percent, or to about 9.5 weight percent, or to about 9.0 weight percent, or to about 8.5 weight percent, or to about 8.0 weight percent, or to about 7.5 weight percent, or to about 7.0 weight percent, or to about 6.5 weight percent, or to about 6.0 weight percent, or to about 5.5 weight percent, or to about 5.0 weight percent, or to about 4.5 weight percent, or to about 4.0 weight percent, or to about 3.5 weight percent, or to about 3.0 weight percent, or to about 2.5 weight percent, or to about 2.0 weight percent, or to about 1.5 weight percent; or from about 1.5 weight percent, or from about 2.0 weight percent, or from about 2.5 weight percent, or from about 3.0 weight percent, or from about 3.5 weight percent, or from about 4.0 weight percent, or from about 4.5 weight percent, or from about 5.0 weight percent, or from about 5.5 weight percent, or from about 6.0 weight percent, or from about 6.5 weight percent, or from about 7.0 weight percent, or from about 7.5 weight percent, or from about 8.0 weight percent, or from about 8.5 weight percent, or from about 9.0 weight percent, or from about 9.5 weight percent to about 10.0 weight percent; or a range made from any two of the foregoing weight percents,

In an example, the present disclosure provides an extrudate including an example of a composition. Extrudates may be produced by forcing a composition through a die, resulting in the production of a shaped composition. An extrusion setup may include a motor, which may act as a drive unit; an extrusion barrel; a rotating screw; and an extrusion die. An extruder may rotate the screw at a predetermined speed, and may be connected to a central electronic control unit in order to monitor and control the process parameters, such as screw speed and temperature, and therefore pressure.

In an example, a copolymer may be a product of a composition or an extrudate that is exposed to a temperature of above about 50° C. In certain examples, the copolymer may be produced by exposure of a composition or an extrudate to a temperature of from about 50° C. to about 200° C., or to about 195° C., or to about 190° C., or to about 185° C., or to about 180° C., or to about 175° C., or to about 170° C., or to about 165° C., or to about 160° C., or to about 155° C., or to about 150° C., or to about 145° C., or to about 140° C., or to about 135° C., or to about 130° C., or to about 125° C., or to about 120° C., or to about 115° C., or to about 110° C., or to about 105° C., or to about 100° C., or to about 95° C., or to about 90° C., or to about 85° C., or to about 80° C., or to about 75° C., or to about 70° C., or to about 65° C., or to about 60° C., or to about 55° C.; or from about 55° C., or from about 60° C., or from about 65° C., or from about 70° C., or from about 75° C., or from about 80° C., or from about 85° C., or from about 90° C., or from about 95° C., or from about 100° C., or from about 105° C., or from about 110° C., or from about 115° C., or from about 120° C., or from about 125° C., or from about 130° C., or from about 135° C., or from about 140° C., or from about 145° C., or from about 150° C., or from about 155° C., or from about 160° C., or from about 165° C., or from about 170° C., or from about 175° C., or from about 180° C., or from about 185° C., or from about 190° C., or from about 195° C. to about 200° C.; or a range formed from any two of the foregoing temperatures; including any sub-ranges therebetween.

In an example, a copolymer that is deconstructable upon exposure to an acidic media. In certain examples, the deconstructing includes contacting the copolymer with, or immersing the copolymer in, an acidic solution in a solvent. Examples of acidic solutions may include solutions of HCl, HI, Br, H₂SO₄, H₃O⁺, HNO₃, H₃PO₄, and CH₃CO₂H in a solvent. In certain examples, a concentration of the acid in the solvent may be from 0.5 M to 6.0 M, including from 0.5 M, or from 1.0 M, or from 1.5 M, or from 2.0 M, or from 2.5 M, or from 3.0 M, or from 3.5 M, or from 4.0 M, or from 4.5 M, or from 5.0 M, or from 5.5 M; or to 1.0 M, or to 1.5 M, or to 2.0 M, or to 2.5 M, or to 3.0 M, or to 3.5 M, or to 4.0 M, or to 4.5 M, or to 5.0 M, or to 5.5 M; or a range made from any two of the foregoing concentrations, including any subranges therebetween. In other examples, a solvent may be water or an ether. Examples of ether solvents may include cyclopentyl methyl ether (“CPME”), diethyl ether (“Et₂O”), diglyme (diethylene glycol dimethyl ether), 1,2-dimethoxyethane (“DME”), 1,4-dioxane, methyl t-butyl ether (“MTBE”), tetrahydrofuran (“THF”), and the like.

In an example, the present disclosure provides a method of increasing a pot life and/or a working life of a thermoset resin composition, including: adding an amount of a compound of formula (I) to a composition including an amount of a functionalized cycloalkene and a catalyst. In certain examples, the amount of the compound of formula (I) may be up to 20 mol % relative to the amount of the functionalized cycloalkene. In other examples, the pot life and/or the working life is increased to a duration of at least 1 hour. In still other examples, the working life and/or the pot life of the composition may be increased based on the amount of the compound of formula (I) in the composition.

In an example, the present disclosure provides a method of preparing a copolymer. The method includes: agitating a mixture including an amount of a compound of formula (I), an amount of a functionalized cycloalkene, and a catalyst, the amount of the compound of formula (I) of up to 20 mol % relative to the amount of the functionalized cycloalkene to provide a thermoset resin composition; and heating the thermoset resin composition to produce the copolymer, the heating after a duration of a pot life and/or a working life. In certain examples, the working life and/or the pot life of the composition may be increased based upon the amount of the compound of formula (I) in the composition. In other examples, the method may further include extruding the thermoset resin composition after the agitating. In still other examples, the heating may include heating to a temperature of at least about 50° C. In still other examples, the heating may include applying the thermoset resin composition to a surface that is heated to a temperature of at least about 50° C.

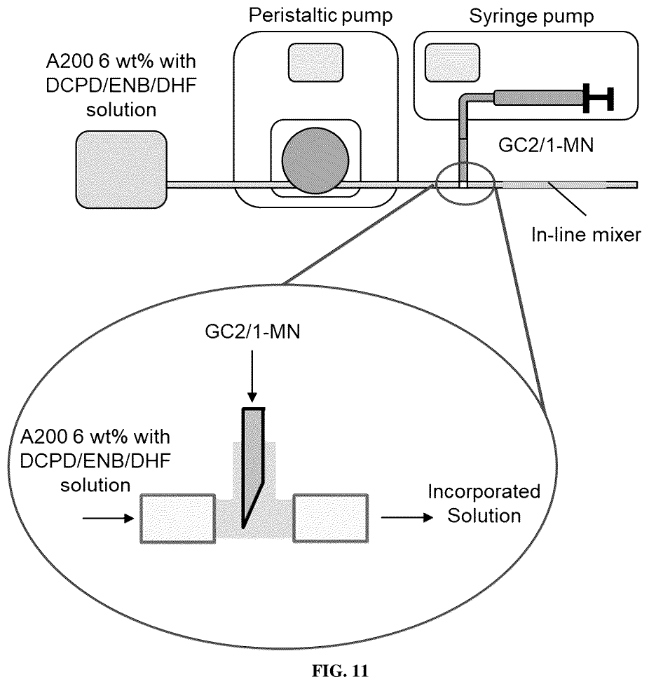

In an example, the present disclosure provides a delivery device for a thermoset resin composition. An example of the delivery device is illustrated in FIG. 11. The delivery device includes a reservoir including a mixture including an amount of a functionalized cycloalkene and a compound of formula (I). Optionally, the reservoir may also include a rheological modifier. The delivery device further includes a first pump in fluid communication with the reservoir and a mixer, the first pump configured to deliver the mixture at a flow rate to the mixer. Examples of the first pump may include a peristaltic pump. Examples of the mixer may include an in-line mixer. The delivery device further includes a second pump in fluid communication with the mixer and configured to deliver a solution of a catalyst at a second flow rate to the mixer. Examples of the second pump may include a syringe pump. The mixer may be configured to agitate the mixer and the catalyst so as to provide a thermoset resin composition. The mixer also includes an outlet configured to deliver the thermoset resin composition. In certain examples, the delivery device may further include an extruder in fluid communication with the in-line mixer, the extruder configured to deliver the thermoset resin composition as an extrudate. In other examples, the mixer may be configured to maintain the thermoset resin composition at a predetermined temperature at or below about 25° C. In still other examples, the predetermined temperature may be at or below about 20° C., or at or below about 15° C., or at or below about 10° C., or at or below about 5° C., or at or below 0° C.

The compositions and processes described above may be better understood in connection with the following Examples. In addition, the following non-limiting examples are an illustration.

The illustrated methods are applicable to other examples of compounds of formula (I) of the present disclosure. The procedures described as general methods describe what is believed will be typically effective to prepare the compositions indicated. However, the person skilled in the art will appreciate that it may be necessary to vary the procedures for any given examples of the present disclosure, for example, vary the order or steps and/or the chemical reagents used.

### EXAMPLES

### I. Materials

All reactions and experiments, unless otherwise noted, were performed under an ambient atmosphere. Reagents, including dicyclopentadiene (“DCPD,” ≥96%), 5-ethylidene-2-norbornene (ENB, 99%), norbornene (NBE, 98%), second generation Grubbs catalyst ([(SIMes)Ru(═CHPh)(PCy₃)Cl₂], “G2”), 2,3-dihydrofuran (“DHF”), and cyclopentyl methyl ether (“CPME”), were purchased from Sigma-Aldrich and used without further purification.

### II. Characterization

A. Differential Scanning Calorimetry

Differential scanning calorimetry (“DSC”) experiments were performed on a TA Discovery DSC 250 instrument. Samples were transferred into aluminum hermetic DSC pans at room temperature, and sealed. The sample mass was determined using an analytical balance (XPE205, Mettler-Toledo) and carefully maintained between 5 milligrams and 10 milligrams. The specific heat capacity was determined by comparison to a sapphire standard. Each sample was subjected to three thermal cycles (heat, cool, and second heat). Samples were subjected to a first heating ramp from −50 to 200° C. at a rate of 150 C min⁻¹, and subsequently cooled to −50 at a rate of 15° C.·min⁻¹. The second heat scan occurred at a ramp rate of 5° C.·min⁻¹ over the same temperature range. The glass transition temperatures (T_{g}) were determined from the midpoint of the thermal transition observed in the second heat scan.

### III. Preparation of poly(dicyclopentadiene)-co-poly(2,3-dihydrofuran) (poly(DCPD-co-DHF)) via FROMP

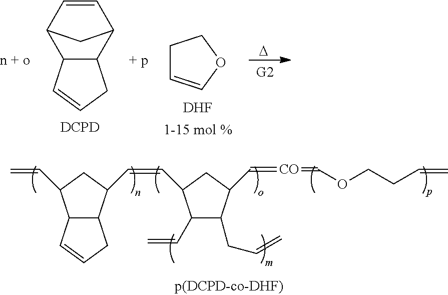

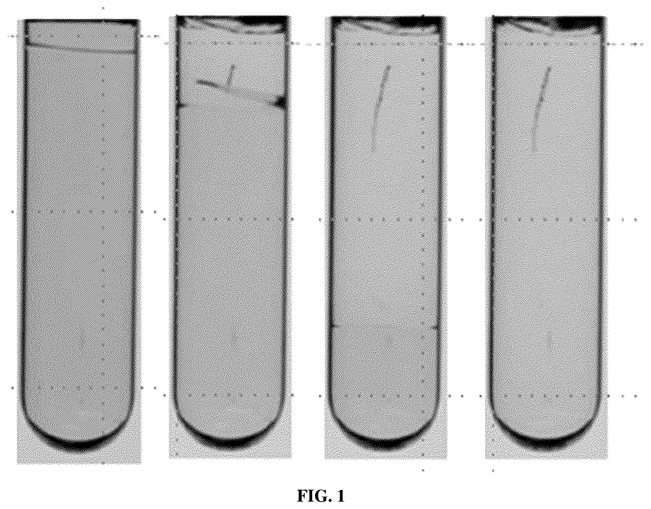

In an example, a resin for polymerization was prepared using the following composition, including a compound of formula (I). Dicyclopentadiene (“DCPD,” 4.93 g, 37 mmol, 1 equiv.), 5-ethylidene-2-norbornene (“ENB,” 0.25 g, 2 mmol, 0.055 equiv.), 2,3-dihydrofuran (“DHF,” 26-400 mg, 0.37-5.6 mmol, 0.01-0.15 equiv.), and G2 (3.2-4.64 mg, 100 ppm vs. total olefin content). DCPD containing 5 weight % ENB was mixed with varying concentrations of DHF (1-15 mol % vs. DCPD). To this mixture, G2 was added, and the mixture was subsequently sonicated for 5 minutes to assure complete catalyst dissolution. The resin was then transferred to either a 13×100 mm glass vial (for front speed determination) or an ASTM IV silicone dog bone mold for mechanical and material characterization (molds were preheated at 65° C. to prevent front quenching). FROMP was initiated using a hot soldering iron in both cases. FIG. 1 illustrates optical images of FROMP of a reaction mixture including 2.5 mol % DHF as the reaction front advances through the glass vials. Resins with rheological modifiers consisted of DHF (0.5-1.5 mol %), DCPD (15 g), and 6 weight % Aerosil A200 fumed silica. These resin mixtures increased the viscosity for extrusion from ˜20 cp to ˜2000 cp within minutes. 100 ppm (9.63 mg) of G2 was dissolved in 1-methylnaphthalene (0.49 μL) to aid in dissolution into the viscous resin mixtures. The catalyst mixture was added to the resin mixtures and mixed using a Thinky Mixer for 30 seconds at 2000 RPM.

### IV. Material Property Characterization of Poly(DCPD-co-DHF)

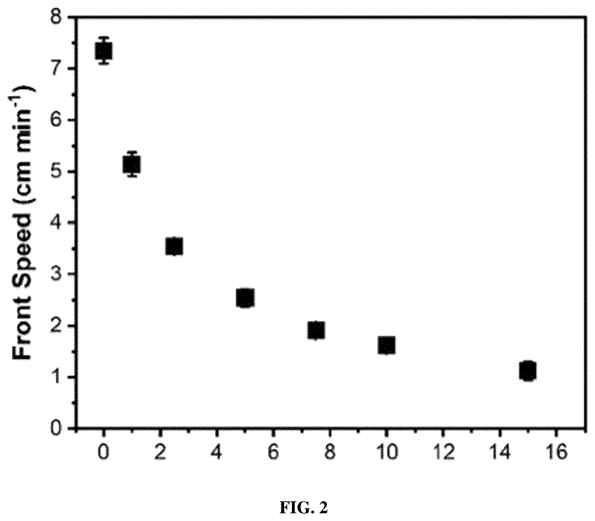

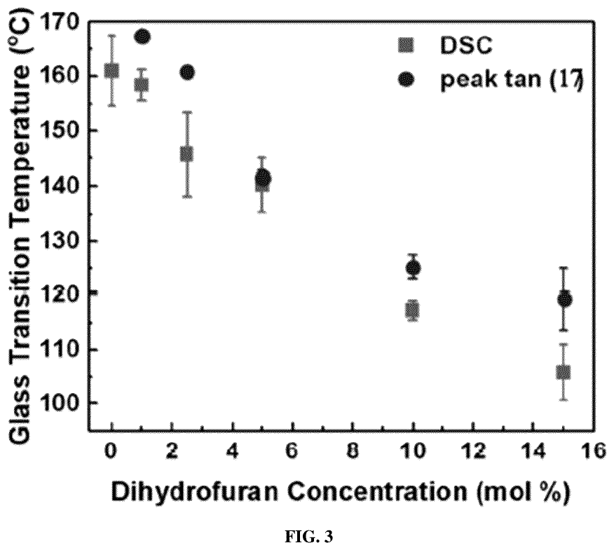

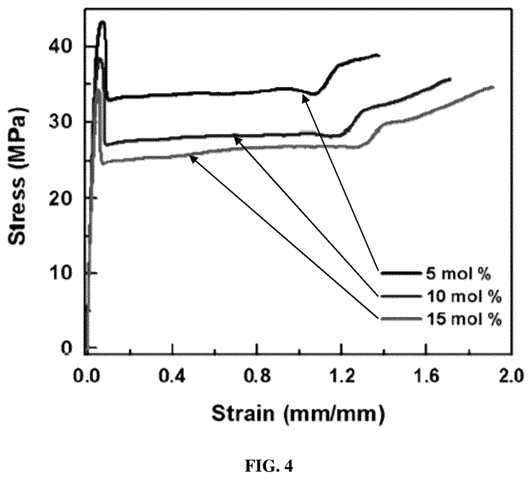

As illustrated in FIG. 2, FROMP reaction front speeds and maximum temperature decreased with increasing amounts of DHF. FIG. 3 illustrates glass transition temperature (T_{g}), which decreases with increasing DHF content. Glass transition temperature was measured using differential scanning calorimetry (second heating cycle at 10° C./min, n=5) and using dynamic mechanical analysis (determined at peak tan(6), 2° C./min, n=3). Without being bound by theory, glass transition temperature decreases because the incorporation of DHF into the polymer backbone may increase the flexibility of the polymer as compared to pure poly(DCPD), which may shift the onset of long-range segmental motion. Further, without being bound by theory, DHF may decrease the crosslinking density of poly(DCPD), which has been determined via the rubbery plateau of the storage modulus and applying rubber elasticity. FIG. 4 and able 1 below illustrate the mechanical properties of copolymers of poly(DCPD) prepared from compositions with 5, 10, and 15 mol % of DHF via quasi-static tensile testing, and demonstrate that the copolymers are sufficiently tough.

TABLE 1
Mechanical Characterization of poly(DCPD-co-DHF)

| [DHF] | Young's Modulus | Ultimate Strength | Strain to Failure |
|---|---|---|---|
| (mol %) | (GPa) | (MPa) | (mm/mm) |
| 5 | 1.2 ± 0.0 | 40.2 ± 1.4 | 1.03 ± 0.53 |
| 10 | 1.1 ± 0.0 | 36.7 ± 1.6 | 1.07 ± 0.54 |
| 15 | 1.0 ± 0.0 | 36.4 ± 1.9 | 1.65 ± 0.38 |

### V. Three-Dimensional Printing of Poly(DCPD-co-DHF) Copolymer

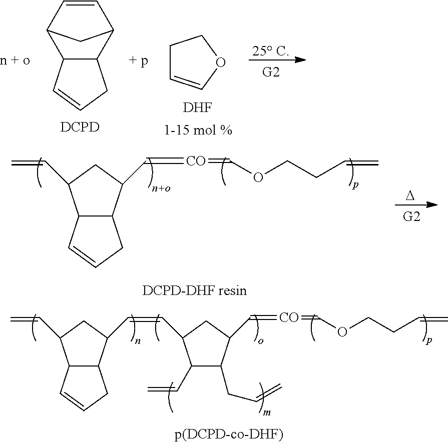

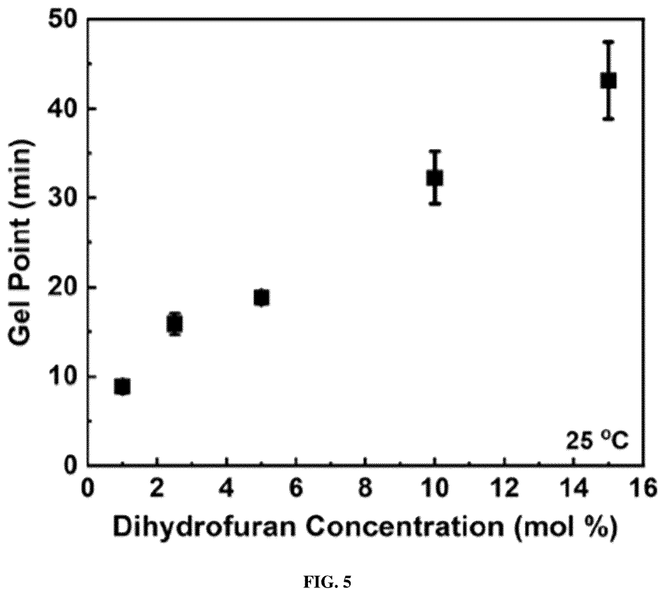

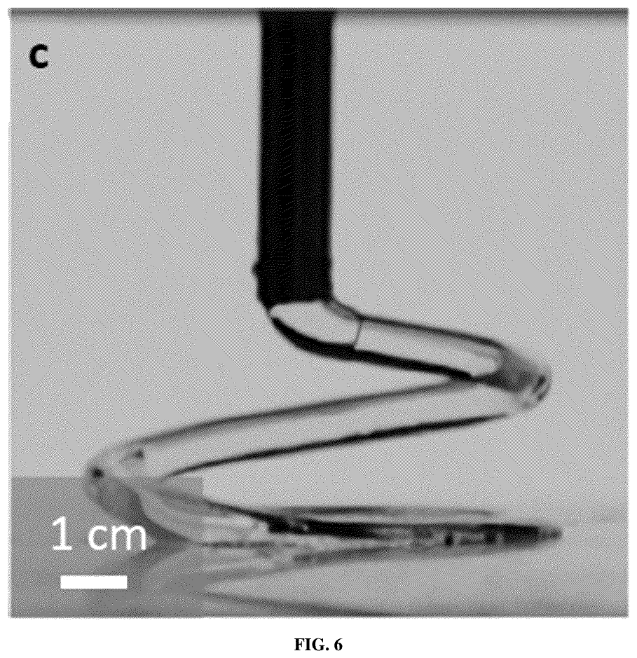

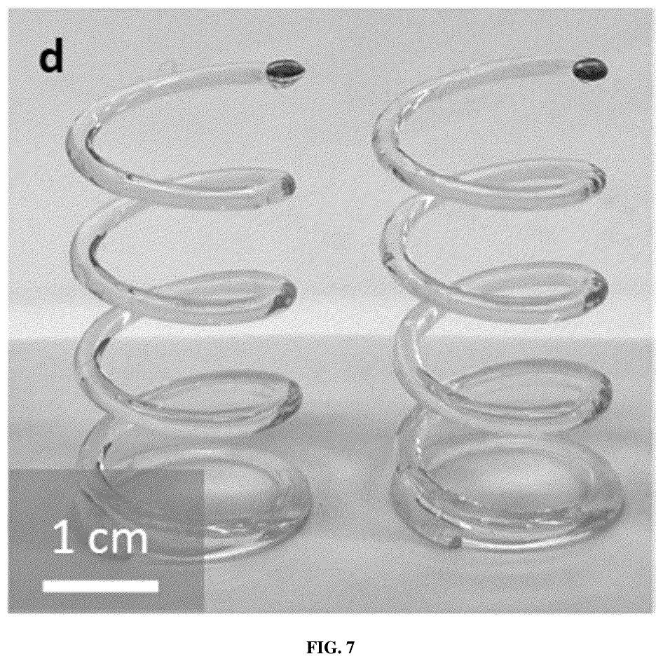

Resins including DCPD and 5-15 mol % DHF were maintained at 25° C. for a given duration of time to reach a gelled state, the duration of time depending on the mol % of DHF. As illustrated in FIG. 5, gel points of the resins, as determined by the intersection of the storage and loss modulus via parallel plate rheology, were found to be directly proportional to the concentrations of DHF in the resins. After reaching the gel point, resins were transferred into a printing barrel maintained at 5° C. to reduce rate of reaction and prevent further increases in viscosity. As an illustration, the resin was then extruded onto a heated substrate at temperature of 100° C., so as to generate helical structures as illustrated in FIGS. 6 and 7.

### VI. Acid-Triggered Deconstruction of Poly(DCPD-co-DHF) Copolymer Thermosets

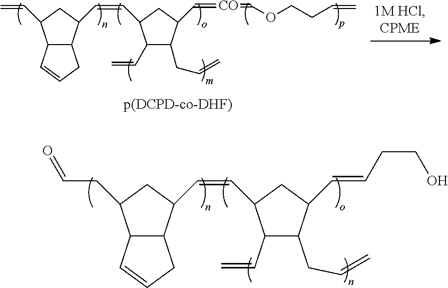

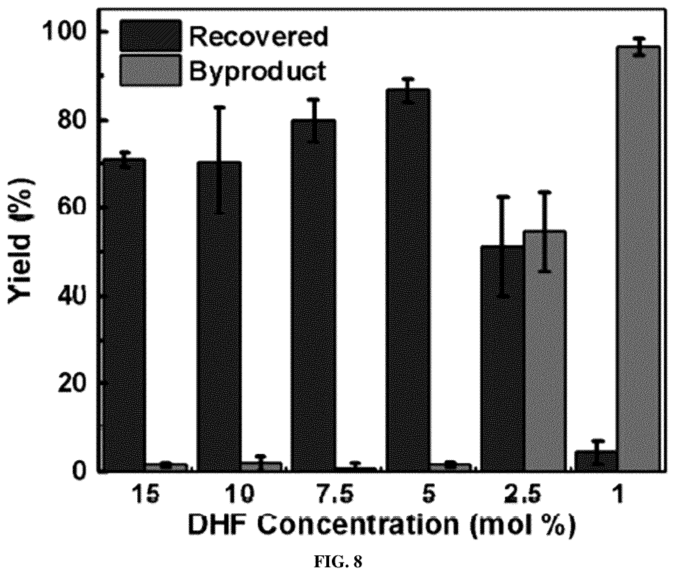

A sample (˜400 mg) was immersed in a 10 mL solution of 1 M HCl in cyclopentyl methyl ether (CPME). After 18 hours, the solution was filtered to remove any insoluble byproducts, which were subsequently dried and weighed. The rest of the mixture, including the recovered products, was precipitated into methanol and subsequently dried and weighed. FIG. 8 illustrates the quantification of byproduct yield as determined by gravimetric analysis.

### VII. Rheological Modification of DCPD-DHF Resins

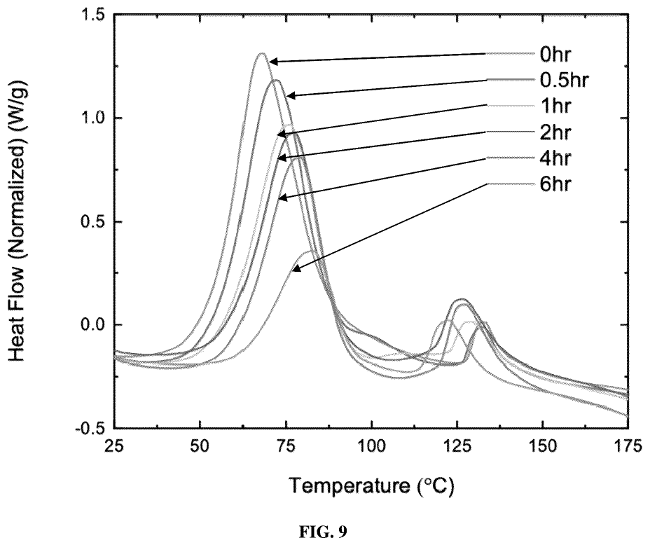

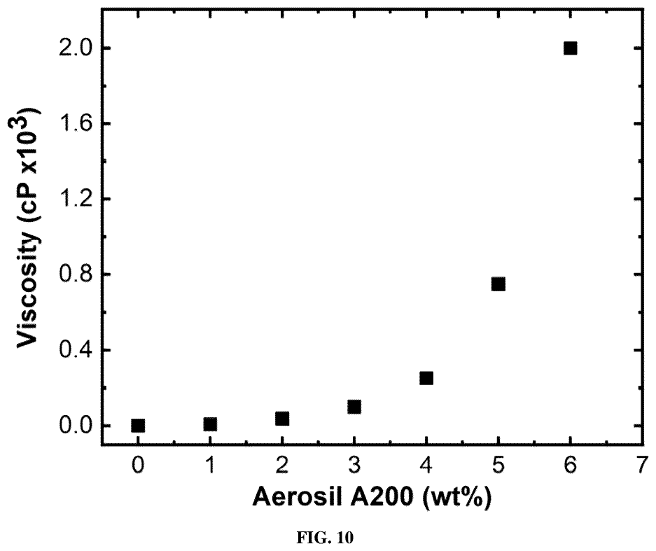

By replacing phosphite inhibitors, which demonstrated adverse interactions with fumed silica, with one or more compounds of formula (I), stable resins were obtained that were found to be reactive even after 6 hours, which is demonstrated by the presence of a substantial exotherm, as illustrated in FIG. 9. Fumed silica may act as a rheological modifier, as depicted by the increase in viscosity to ˜2000 cp with the addition of 6 weight percent of Aerosil A200, as illustrated in FIG. 10. Further, Table 2 below demonstrates the thermochemical properties of rheologically modified resins including 6 weight percent Aerosil A200.

TABLE 2
Thermal Characterization of DCPD-DHF Resins Including 6 Weight
Percent Aerosil A200 Using Differential Scanning Calorimetry

| | Onset | | | |
|---|---|---|---|---|
| [DHF] | Temperature | | | Degree of cure |
| (mol %) | (° C.) | Enthalpy (J/g) | T_{g} (° C.) | (%) |
| 0.5 | 51.0 ± 1.4 | 378 ± 5 | 131 ± 3 | 98.9 ± 0.4 |
| 1.0 | 53.4 ± 0.1 | 385 ± 6 | 128 ± 2 | 99.4 ± 0.2 |
| 1.5 | 50.9 ± 2.4 | 382 ± 5 | 129 ± 2 | 99.1 ± 0.3 |

Table 3 below illustrates the advantageous stability of resins including one or more compounds of formula (I), for example, DHF, with reactivity even for periods longer than 4 hours and up to 6 hours after mixing.

TABLE 3
Resin Working Time

| DCPD Formulation | Printing Window | | Tg (° C.) |
|---|---|---|---|
| 1 equiv. TBP | ~2 hours after | | 161 ± 7 |
| | 6 hour incubation | | |
| 1 equiv. TBP + 6 weight % | <3 | minutes | \hat{ } |
| A200 | | | |
| 1.0 mol %* DHF + 6 weight | >4 | hours | 131 ± 2 |
| % A200 | | | |

*1.0 mol % is approximately 100 molar equivalents, relative to G2 catalyst.
\hat{ } Unable to obtain due to spontaneous polymerization.

Although the present disclosure has been described with reference to examples and the accompanying drawings, the present disclosure is not limited thereto, but may be variously modified and altered by those skilled in the art to which the present disclosure pertains without departing from the spirit and scope of the present disclosure.

The subject-matter of the disclosure may also relate, among others, to the following aspects:

A first aspect relates to a thermoset resin composition, comprising: an amount of a functionalized cycloalkene; a catalyst; and an amount of a compound (I) of up to 20 mol % relative to the amount of the functionalized cycloalkene:

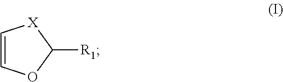

wherein R₁ is selected from the group consisting of hydrogen, substituted or unsubstituted (C₁-C₂₀)alkyl, and substituted or unsubstituted aryl; X is selected from the group consisting of oxygen and CH—R₂; R₂ is selected from the group consisting of hydrogen, substituted or unsubstituted (C₁-C₂₀)alkyl, and substituted or unsubstituted aryl; and each substituted (C₁-C₂₀)alkyl and substituted aryl is independently selected with one or more (C₁-C₂₀)alkoxy groups or aryloxy groups; and wherein the working life and/or the pot life of the composition is at least 1 hour.

A second aspect relates to the composition of aspect 1, further comprising a rheological modifier.

A third aspect relates to the composition of aspect 2, wherein the rheological modifier is fumed silica.

A fourth aspect relates to the composition of any preceding aspect, wherein the functionalized cycloalkene is selected from the group consisting of dicyclopentadiene, 1,5-cyclooctadiene, norbornene, 5-ethylidene-2-norbornene, and mixtures thereof.

A fifth aspect relates to the composition of any preceding aspect, wherein the catalyst is G2.

A sixth aspect relates to the composition of any preceding aspect, wherein the compound of formula (I) is selected from the group consisting of 2,3-dihydrofuran, 2-(4-methoxyphenyl)-2,3-dihydrofuran, 2-(ethoxymethyl)-2,3-dihydrofuran, 3-methyl-2,3-dihydrofuran, 2-phenyl-2,3-dihydrofuran, 1,3-dioxole, and mixtures thereof.

A seventh aspect relates to the composition of any preceding aspect, wherein the working life and/or the pot life of the composition is from 2 hours to 6 hours.

An eighth aspect relates to the composition of any preceding aspect, comprising from 0.5 mol % to 15 mol % of the compound of formula (I).

A ninth aspect relates to the composition of any preceding aspect, comprising 1 mol % of the compound of formula (I) and from about 1 wt. % to about 10 wt. % of fumed silica based on 100 wt. % of the composition.

A tenth aspect relates to the composition of any preceding aspect, wherein the working life and/or the pot life of the composition is tunable based upon the amount of the compound of formula (I) in the composition.

An eleventh aspect relates to an extrudate comprising the composition of any preceding aspect.

A twelfth aspect relates to a copolymer that is a product of the composition of any one of aspects 1 to 10 or the extrudate of aspect 11 that is exposed to a temperature above about 50° C.

A thirteenth aspect relates to the copolymer of aspect 12 that is deconstructable upon exposure to an acidic media.

A fourteenth aspect relates to a method of increasing a pot life and/or a working life of a thermoset resin composition, comprising: adding an amount of a compound of formula (I) to the composition, the composition comprising an amount of a functionalized cycloalkene and a catalyst, the amount of the compound of formula (I) of up to 20 mol % relative to the amount of the functionalized cycloalkene;

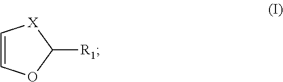

wherein R₁ is selected from the group consisting of hydrogen, substituted or unsubstituted (C₁-C₂₀)alkyl, and substituted or unsubstituted aryl; X is selected from the group consisting of oxygen and CH—R₂; R₂ is selected from the group consisting of hydrogen, substituted or unsubstituted (C₁-C₂₀)alkyl, and substituted or unsubstituted aryl; and each substituted (C₁-C₂₀)alkyl and substituted aryl is independently substituted with one or more (C₁-C₂₀)alkoxy groups or aryloxy groups; and wherein the pot life and/or the working life is increased to a duration of at least 1 hour.

A fifteenth aspect relates to the method of aspect 14, wherein the composition further comprises a rheological modifier.

A sixteenth aspect relates to the method of aspect 15, wherein the rheological modifier is fumed silica.

A seventeenth aspect relates to the method of any one of aspects 14 to 16, wherein the functionalized cycloalkene is selected from the group consisting of dicyclopentadiene, 1,5-cyclooctadiene, norbornene, 5-ethylidene-2-norbornene, and mixtures thereof.

An eighteenth aspect relates to the method of any one of aspects 14 to 17, wherein the catalyst is G2.

A nineteenth aspect relates to the method of any one of aspects 14 to 18, wherein the compound of formula (I) is selected from the group consisting of 2,3-dihydrofuran, 2-(4-methoxyphenyl)-2,3-dihydrofuran, 2-(ethoxymethyl)-2,3-dihydrofuran, 3-methyl-2,3-dihydrofuran, 2-phenyl-2,3-dihydrofuran, 1,3-dioxole, and mixtures thereof.

A twentieth aspect relates to the method of any one of aspects 14 to 19, wherein the working life and/or the pot life of the composition is from 2 hours to 6 hours.

A twenty-first aspect relates to the method of any one of aspects 14 to 20, wherein the adding comprises the compound of formula (I) in the amount of from 0.5 mol % to 15 mol %.

A twenty-second aspect relates to the method of any one of aspects 14 to 21, wherein the adding comprises the compound of formula (I) in the amount of 1 mol %.

A twenty-third aspect relates to the method of any one of aspects 14 to 22, wherein the composition further comprises from about 1 wt. % to about 10 wt. % of fumed silica based on 100 wt. % of the composition.

A twenty-fourth aspect relates to the method of any one of aspects 14 to 23, wherein the working life and/or the pot life of the composition is increased based upon the amount of the compound of formula (I) in the composition.

A twenty-fifth aspect relates to a method of preparing a copolymer, comprising: agitating a mixture comprising an amount of a compound of formula (I), an amount of a functionalized cycloalkene, and a catalyst, the amount of the compound of formula (I) of up to 20 mol % relative to the amount of the functionalized cycloalkene to provide a thermoset resin composition;

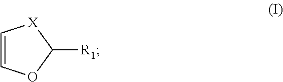

wherein R₁ is selected from the group consisting of hydrogen, substituted or unsubstituted (C₁-C₂₀)alkyl, and substituted or unsubstituted aryl; X is selected from the group consisting of oxygen and CH—R₂; R₂ is selected from the group consisting of hydrogen, substituted or unsubstituted (C₁-C₂₀)alkyl, and substituted or unsubstituted aryl; and each substituted (C₁-C₂₀)alkyl and substituted aryl is independently substituted with one or more (C₁-C₂₀)alkoxy groups or aryloxy groups; and heating the thermoset resin composition to produce the copolymer after a duration of a pot life and/or a working life.

A twenty-sixth aspect relates to the method of aspect 25, wherein the mixture further comprises a rheological modifier.

A twenty-seventh aspect relates to the method of aspect 26, wherein the rheological modifier is fumed silica.

A twenty-eighth aspect relates to the method of any one of aspects 25 to 27, wherein the functionalized cycloalkene is selected from the group consisting of dicyclopentadiene, 1,5-cyclooctadiene, norbornene, 5-ethylidene-2-norbornene, and mixtures thereof.

A twenty-ninth aspect relates to the method of any one of aspects 25 to 28, wherein the catalyst is G2.

A thirtieth aspect relates to the method of any one of aspects 25 to 29, wherein the compound of formula (I) is selected from the group consisting of 2,3-dihydrofuran, 2-(4-methoxyphenyl)-2,3-dihydrofuran, 2-(ethoxymethyl)-2,3-dihydrofuran, 3-methyl-2,3-dihydrofuran, 2-phenyl-2,3-dihydrofuran, 1,3-dioxole, and mixtures thereof.

A thirty-first aspect relates to the method of any one of aspects 25 to 30, wherein the duration of the working life and/or the pot life of the composition is from 2 hours to 6 hours.

A thirty-second aspect relates to the method of any one of aspects 25 to 31, wherein the mixture comprises the compound of formula (I) in the amount of from 0.5 mol % to 15 mol %.

A thirty-third aspect relates to the method of any one of aspects 25 to 32, wherein the mixture comprises the compound of formula (I) in the amount of 1 mol %.

A thirty-fourth aspect relates to the method of any one of aspects 25 to 33, wherein the mixture further comprises from about 1 wt. % to about 10 wt. % of fumed silica based on 100 wt. % of the mixture.

A thirty-fifth aspect relates to the method of any one of aspects 25 to 34, wherein the working life and/or the pot life of the composition is increased based upon the amount of the compound of formula (I) in the composition.

A thirty-sixth aspect relates to the method of any one of aspects 25 to 35, further comprising extruding the thermoset resin composition after the agitating.

A thirty-seventh aspect relates to the method of any one of aspects 25 to 36, wherein the heating comprises heating to a temperature of at least about 50° C.

A thirty-eighth aspect relates to the method of any one of aspects 25 to 37, wherein the heating comprises applying the thermoset resin composition to a surface that is heated to a temperature of at least about 50° C.

A thirty-ninth aspect relates to the method of any one of aspects 25 to 38, wherein the copolymer is deconstructed after immersion in an acidic solution.

A fortieth aspect relates to a delivery device for a thermoset resin composition, comprising: a reservoir comprising a mixture comprising an amount of a functionalized cycloalkene and a compound of formula (I);

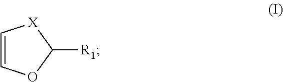

wherein R₁ is selected from the group consisting of hydrogen, substituted or unsubstituted (C₁-C₂₀)alkyl, and substituted or unsubstituted aryl; X is selected from the group consisting of oxygen and CH—R₂; R₂ is selected from the group consisting of hydrogen, substituted or unsubstituted (C₁-C₂₀)alkyl, and substituted or unsubstituted aryl; and each substituted (C₁-C₂₀)alkyl and substituted aryl is independently substituted with one or more (C₁-C₂₀)alkoxy groups or aryloxy groups; a first pump, optionally a peristaltic pump, in fluid communication with the reservoir and a mixer, optionally an inline-mixer, and configured to deliver the mixture at a flow rate to the mixer; a second pump, optionally a syringe pump, in fluid communication with the mixer and configured to deliver a solution of a catalyst at a second flow rate to the mixer; and wherein the mixer is configured to agitate the mixture and the catalyst so as to provide the thermoset resin composition; and wherein the mixer comprises an outlet configured to deliver the thermoset resin composition.

A forty-first aspect relates to the device of aspect 40, wherein the mixture further comprises a rheological modifier.

A forty-second aspect relates to the device of aspect 41, wherein the rheological modifier is fumed silica.

A forty-third aspect relates to the device of aspect 42, wherein the mixture comprises fumed silica in an amount of from about 1 wt. % to about 10 wt. % based on 100 wt. % of the mixture.

A forty-fourth aspect relates to the device of any one of aspects 40 to 43, wherein the functionalized cycloalkene is selected from the group consisting of dicyclopentadiene, 1,5-cyclooctadiene, norbornene, 5-ethylidene-2-norbornene, and mixtures thereof.

A forty-fifth aspect relates to the device of any one of aspects 40 to 44, wherein the catalyst is G2.

A forty-sixth aspect relates to the device of any one of aspects 40 to 45, wherein the compound of formula (I) is selected from the group consisting of 2,3-dihydrofuran, 2-(4-methoxyphenyl)-2,3-dihydrofuran, 2-(ethoxymethyl)-2,3-dihydrofuran, 3-methyl-2,3-dihydrofuran, 2-phenyl-2,3-dihydrofuran, 1,3-dioxole, and mixtures thereof.

A forty-seventh aspect relates to the device of any one of aspects 40 to 46, wherein the mixture comprises the compound of formula (I) in an amount of up to 20 mol % relative to the amount of the functionalized cycloalkene.

A forty-eighth aspect relates to the device of any one of aspects 40 to 47, wherein the mixture comprises from 0.5 to 15 mol % of the compound of formula (I) relative to the amount of the functionalized cycloalkene.

A forty-ninth aspect relates to the device of any one of aspects 40 to 48, wherein the mixture comprises 1 mol % of the compound of formula (I) relative to the amount of the functionalized cycloalkene.

A fiftieth aspect relates to the device of any one of aspects 40 to 49, further comprising an extruder in fluid communication with the in-line mixer, the extruder configured to deliver the thermoset resin composition as an extrudate.

A fifty-first aspect relates to the device of any one of aspects 40 to 50, wherein the in-line mixer is configured to maintain the thermoset resin composition at a predetermined temperature at or below about 25° C.

In addition to the features mentioned in each of the independent aspects enumerated above, some examples may show, alone or in combination, the optional features mentioned in the dependent aspects and/or as disclosed in the description above and shown in the figures.

What is claimed is:

1. A thermoset resin composition, comprising:
an amount of a functionalized cycloalkene;
a catalyst; and
an amount of a compound of formula (I) of up to 20 mol % relative to the amount of the functionalized cycloalkene: 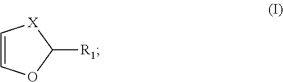
wherein R₁ is selected from the group consisting of hydrogen, substituted or unsubstituted (C₁-C₂₀)alkyl, and substituted or unsubstituted aryl;
X is selected from the group consisting of oxygen and CH—R₂;
R₂ is selected from the group consisting of hydrogen, substituted or unsubstituted (C₁-C₂₀)alkyl, and substituted or unsubstituted aryl; and
each substituted (C₁-C₂₀)alkyl and substituted aryl is independently substituted with one or more (C₁-C₂₀)alkoxy groups or aryloxy groups; and
wherein the working life and/or the pot life of the composition is at least 1 hour.

2. The composition of claim 1, further comprising a rheological modifier.

3. The composition of claim 1, wherein the functionalized cycloalkene is selected from the group consisting of dicyclopentadiene, 1,5-cyclooctadiene, norbornene, 5-ethylidene-2-norbornene, and mixtures thereof.

4. The composition of claim 1, wherein the catalyst is G2.

5. The composition of claim 1, wherein the compound of formula (I) is selected from the group consisting of 2,3-dihydrofuran, 2-(4-methoxyphenyl)-2,3-dihydrofuran, 2-(ethoxymethyl)-2,3-dihydrofuran, 3-methyl-2,3-dihydrofuran, 2-phenyl-2,3-dihydrofuran, 1,3-dioxole, and mixtures thereof.

6. The composition of claim 1, wherein the working life and/or the pot life of the composition is from 2 hours to 6 hours.

7. The composition of claim 1, comprising from 0.5 mol % to 15 mol % of the compound of formula (I).

8. The composition of claim 1, wherein the working life and/or the pot life of the composition is tunable based upon the amount of the compound of formula (I) in the composition.

9. An extrudate comprising the composition of claim 1.

10. A copolymer that is a product of the composition of claim 1 exposed to a temperature above about 50° C.

11. A delivery device for the composition of claim 1, comprising:
a reservoir comprising a mixture comprising the amount of the functionalized cycloalkene and the amount of the compound of formula (I); 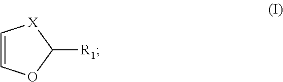
wherein R₁ is selected from the group consisting of hydrogen, substituted or unsubstituted (C₁-C₂₀)alkyl, and substituted or unsubstituted aryl;
X is selected from the group consisting of oxygen and CH—R₂;
R₂ is selected from the group consisting of hydrogen, substituted or unsubstituted (C₁-C₂₀)alkyl, and substituted or unsubstituted aryl; and
each substituted (C₁-C₂₀)alkyl and substituted aryl is independently substituted with one or more (C₁-C₂₀)alkoxy groups or aryloxy groups;
a first pump, optionally a peristaltic pump, in fluid communication with the reservoir and a mixer, optionally an in-line mixer, and configured to deliver the mixture at a flow rate to the mixer; and
a second pump, optionally a syringe pump, in fluid communication with the mixer and configured to deliver a solution of the catalyst at a second flow rate to the mixer;
wherein the mixture is configured to agitate the mixture and the catalyst so as to provide the thermoset resin composition; and
wherein the mixture comprises an outlet configured to deliver the thermoset resin composition.

12. The device of claim 11, wherein the mixture further comprises a rheological modifier.

13. The device of claim 12, wherein the rheological modifier is fumed silica.

14. The device of claim 13, wherein the fumed silica is in an amount of from about 1 wt. % to about 10 wt. % based on 100 wt. % of the mixture.

15. The device of claim 10, wherein the functionalized cycloalkene is selected from the group consisting of dicyclopentadiene, 1,5-cyclooctadiene, norbornene, 5-ethylidene-2-norbornene, and mixtures thereof.

16. The device of claim 10, wherein the mixture comprises the compound of formula (I) in an amount of up to 20 mol % relative to the amount of the functionalized cycloalkene; and
wherein the compound of formula (I) is selected from the group consisting of 2,3-dihydrofuran, 2-(4-methoxypehnyl)-2,3-dihydrofuran, 2-(ethoxymethyl)-2,3-dihydrofuran, 3-methyl-2,3-dihydrofuran, 2-phenyl-2,3-dihydrofuran, 1,3-dioxole, and mixtures thereof.

17. A method of increasing a pot life and/or a working life of a thermoset resin composition, comprising:
adding an amount of a compound of formula (I) to the composition, the composition comprising an amount of a functionalized cycloalkene and a catalyst, the amount of the compound of formula (I) of up to 20 mol % relative to the amount of the functionalized cycloalkene; 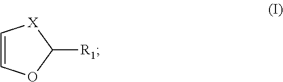
wherein R₁ is selected from the group consisting of hydrogen, substituted or unsubstituted (C₁-C₂₀)alkyl, and substituted or unsubstituted aryl;
X is selected from the group consisting of oxygen and CH—R₂;
R₂ is selected from the group consisting of hydrogen, substituted or unsubstituted (C₁-C₂₀)alkyl, and substituted or unsubstituted aryl; and
each substituted (C₁-C₂₀)alkyl and substituted aryl is independently substituted with one or more (C₁-C₂₀)alkoxy groups or aryloxy groups; and
wherein the pot life and/or the working life is increased to a duration of at least 1 hour.

18. The method of claim 17, wherein the composition further comprises a rheological modifier.

19. A method of preparing a copolymer, comprising:
agitating a mixture comprising an amount of a compound of formula (I), an amount of a functionalized cycloalkene, and a catalyst, the amount of the compound of formula (I) of up to 20 mol % relative to the amount of the functionalized cycloalkene to provide a thermoset resin composition; 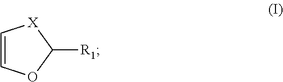
wherein R₁ is selected from the group consisting of hydrogen, substituted or unsubstituted (C₁-C₂₀)alkyl, and substituted or unsubstituted aryl;
X is selected from the group consisting of oxygen and CH—R₂;
R₂ is selected from the group consisting of hydrogen, substituted or unsubstituted (C₁-C₂₀)alkyl, and substituted or unsubstituted aryl; and
each substituted (C₁-C₂₀)alkyl and substituted aryl is independently substituted with one or more (C₁-C₂₀)alkoxy groups or aryloxy groups; and
heating the thermoset resin composition to produce the copolymer after a duration of a pot life and/or a working life.

20. The method of claim 19, wherein the mixture further comprises a rheological modifier.
